(19) United States
(12) Patent Application Publication
(10) Pub. No.: US 2025/0139455 A1
(43) Pub. Date: May 1, 2025

(54) SYSTEMS AND METHODS FOR MINIMIZING DEVELOPMENT TIME IN ARTIFICIAL INTELLIGENCE MODELS USING DYNAMIC DATASET FITTINGS

(71) Applicant: Capital One Services, LLC, McLean, VA (US)

(72) Inventor: Michael LANGFORD, Plano, TX (US)

(73) Assignee: Capital One Services, LLC, McLean, VA (US)

(21) Appl. No.: 18/498,310

(22) Filed: Oct. 31, 2023

(51) Int. Cl. G06N 3/0985

(52) U.S. Cl. CPC G06N 3/0985

(57) ABSTRACT

Systems and methods for minimizing development time in artificial intelligence models by automating model selection based on dataset fittings of time-series data prior to hyperparameter optimization. The systems and methods use a scoring policy based on a plurality of labeled datasets that score one or more results contained within the aggregate statistical profile. The system may dynamically identify particular criteria in statistical data that indicates an effectiveness of a given model on a given dataset. These criteria (e.g., the scoring policy) may then be updated over time as new datasets, statistical analyses, and/or aggregated statistical profiles are developed within affecting the underlying models and/or datasets.

### BACKGROUND

In recent years, the use of artificial intelligence, including, but not limited to, machine learning, deep learning, etc. (referred to collectively herein as artificial intelligence models, machine learning models, or simply models), has exponentially increased. Broadly described, artificial intelligence refers to a wide-ranging branch of computer science concerned with building smart machines capable of performing tasks that typically require human intelligence. Key benefits of artificial intelligence are its ability to process data, find underlying patterns, and/or perform real-time determinations. However, despite these benefits and despite the wide-ranging number of potential applications, practical implementations of artificial intelligence have been hindered by several technical problems. First, artificial intelligence may rely on large amounts of high-quality data. The process for obtaining this data and ensuring it is of high quality can be complex and time consuming. Additionally, data that is obtained may need to be categorized and labeled accurately, which can be difficult, time consuming, and a manual task.

Second, artificial intelligence models, particularly models trained on time-series data, require extensive hyperparameter tuning, which itself requires specialized knowledge to design, program, and/or perform the tuning, which can limit the amount of people and resources available to create practical implementations of artificial intelligence models. Hyperparameter tuning is the process of selecting the optimal values for hyperparameters in a model. Hyperparameters are parameters that are set before the learning process begins and control various aspects of the training process. They are not learned from the data but are determined by the user or data scientist based on domain knowledge, experimentation, and heuristics. Hyperparameter tuning is important because the performance of a model is highly dependent on the values of these hyperparameters. Poorly chosen hyperparameters can lead to suboptimal model performance, including overfitting or underfitting. The goal of hyperparameter tuning is to find the set of hyperparameters that result in the best possible performance on the validation or test dataset.

These technical challenges may present an inherent problem with attempting to use artificial intelligence-based solutions for applications involving time-series data.

### SUMMARY

Systems and methods are described herein for novel uses and/or improvements to artificial intelligence applications, particularly in the context of hyperparameter tuning. As one example, systems and methods are described herein for minimizing development time in artificial intelligence models by automating model selection based on dataset fittings of time-series data prior to hyperparameter optimization. As another example, the systems and methods may minimize hyperparameter optimization based on dataset fittings. As yet another example, systems and methods are described herein for novel uses and/or improvements to detection of data trends for data fittings.

In existing model development lifecycles, choosing the best model to fit a given dataset and optimizing its hyperparameters is an incredibly time-consuming and tedious process. This is particularly true for time-series data. For example, in time-series forecasting, some models will be better suited to fit a given dataset of certain attributes such as the seasonal periods, presence of trend, and/or smoothness of the data. As such, certain time-series forecasting models may not be effective if there is no seasonality present in the data, whereas other time-series forecasting models may be very effective if the dataset is stationary. Currently, the method of determining this is to train, fit, and/or tune a plurality of statistical routines, and then validate the results from each model. However, this results in redundant training, fitting, and/or tuning time.

Accordingly, systems and methods described herein aim to reduce the redundancies and improve the efficiencies of model selection, model training, and/or hyperparameter selection. The systems and methods achieve this by using information about the attributes of the time-series dataset that may be used to determine a model that may be most effective at fitting a given dataset. If a model is selected prior to hyperparameter optimization, the time and resources spent training, fitting, and/or tuning models that are not selected can be avoided.

However, determining to select a model prior to hyperparameter optimization and validation raises numerous technical challenges. First, the attributes of the time-series dataset, if known, do not necessarily have a linear relationship with the effectiveness of any given model on any given dataset. For example, datasets may have conflicting (or complementary) attributes that weigh on the effectiveness of a given model, which may not be known until after extensive training and validation. Additionally, some attributes (e.g., whether data is “spiky”—that is, contains large swings) do not have a known determination technique.

As such, the systems and methods gather information about a time-series profile of a given dataset using a plurality of statistical tests to determine details such as stationarity, seasonality, and/or presence of trends. The systems and methods may overcome the technical challenge of a lack of linear relationships between attributes and model effectiveness through the use of an aggregate statistical profile based on the results of a plurality of known statistical analyses. The use of the results of the plurality of known statistical analyses provides a basis for determining potential attributes and correlations between them that may affect the effectiveness of any given model.

To overcome a second technical challenge (i.e., the lack of a known standard for determining correlations between attributes that may affect effectiveness of any given model), the system applies a profiling model to the aggregate statistical profile. For example, the system may apply a profiling model to the aggregate statistical profile using a scoring policy or a time-series embedding of the dataset combined with the aggregate statistical profile. In either case, the profiling model may be trained on the scoring policy and/or a time-series embedding of the dataset combined with the aggregate statistical profile to determine a likelihood of the effectiveness of a given model on the given dataset and/or likely hyperparameters for the given model.

For example, the systems and methods may determine an aggregate statistical profile based on the results of each of the statistical tests. The systems and methods may then determine a likely model, or likely hyperparameters for a given model, by applying a profile model (e.g., based on a scoring policy or embedding) for each model. The systems and methods may then use the results to determine how a given time-series model may be affected (e.g., whether it is benefited, harmed, and/or disqualified entirely) by the attributes present in the dataset.

The systems and methods may then filter, prioritize, and/or select models based on the attributes. For example, the system may disqualify a model and thus prevent further expenditure of time and/or resources related to testing and/or training the model. In contrast, models that are not disqualified may be further scored to allow for non-binary classification and/or analysis to account for the conflicting (or complementary) attributes that weigh on the effectiveness of a given model. Once all remaining models are scored, the system may select the top-scored models to be fit and tuned, and the model with the best validation score may be selected for use by a user. By doing so, the system automates the profiling of the time-series dataset (which gathers information about what makes this dataset unique) and automatically selects and fits the best-suited models to the specific time-series profile. As such, the system saves countless hours for any user who wishes to apply time-series forecasting techniques to a given dataset and allows for the democratization of artificial intelligence by reducing the barrier to entry for many users to start forecasting.

To overcome a third technical challenge (i.e., the lack of a known standard for determining attributes such as spiky data), the system may further use a novel statistical analysis and use the results thereof for populating the aggregate statistical profile. For example, through the use of customized statistical analyses (e.g., based on the dataset and/or known indicia of attributes), the system may determine a likelihood of a dataset having a given property that may affect the effectiveness of a given model. Furthermore, the systems and methods may use a scoring policy based on a plurality of labeled datasets that score one or more results contained within the aggregate statistical profile. By doing so, the system may dynamically identify particular criteria in statistical data that indicates an effectiveness of a given model on a given dataset. These criteria (e.g., the scoring policy) may then be updated over time as new datasets, statistical analyses, and/or aggregated statistical profiles are developed without affecting the underlying models and/or datasets. Thus, the systems and methods produce dynamic dataset fittings.

In some aspects, systems and methods for minimizing development time in artificial intelligence models by automating model selection based on dataset fittings of time-series data prior to hyperparameter optimization are described. For example, the system may receive a first dataset. The system may generate a first feature input based on the first dataset. The system may input the first feature input into a first plurality of statistical routines to determine a first plurality of respective outputs, wherein the first plurality of statistical routines performs a respective first statistical analysis of the first feature input, wherein each of the first plurality of statistical routines is based on a first respective algorithm. The system may determine a first aggregate statistical profile for the first dataset based on the first plurality of respective outputs. The system may select, based on the first aggregate statistical profile, a first untrained model from a first plurality of untrained models for training, wherein the first plurality of untrained models comprises respective algorithms for time-series forecasting, and wherein each of the first plurality of untrained models comprises default hyperparameter tuning. The system may, based on selecting the first untrained model, tune a first hyperparameter of the first untrained model using the first dataset.

In some aspects, systems and methods for minimizing development time in artificial intelligence models by automating model selection based on dynamic dataset fittings of time-series data prior to hyperparameter optimization are described. For example, the system may receive a first plurality of respective outputs from a first plurality of statistical routines, wherein each of the first plurality of statistical routines performs a respective first statistical analysis on a first dataset. The system may determine, based on a first scoring policy, a first aggregate statistical profile for the first dataset based on the first plurality of respective outputs, wherein the first scoring policy is generated using a model, and wherein the model is trained by: receiving a plurality of labeled datasets; generating a scoring policy based on the plurality of labeled datasets; generating, based on the scoring policy, a model selection for processing test datasets; and validating, based on an accuracy of the model selection, the scoring policy. The system may select, based on the first aggregate statistical profile, a first untrained model from a first plurality of untrained models for training, wherein the first plurality of untrained models comprises respective algorithms for time-series forecasting, and wherein each of the first plurality of untrained models comprises default hyperparameter tuning.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1A shows an illustrative diagram of time-series data, in accordance with one or more embodiments.

FIG. 1B shows an illustrative user interface for automating model selection and hyperparameter optimization, in accordance with one or more embodiments.

FIGS. 2A-D show illustrative diagrams for automating model selection based on dataset fittings of time-series data prior to hyperparameter optimization, in accordance with one or more embodiments.

FIG. 3 shows illustrative components for a system used to automate model selection based on dataset fittings of time-series data prior to hyperparameter optimization, in accordance with one or more embodiments.

FIG. 4 shows a flowchart of the steps involved in automating model selection based on dataset fittings of time-series data prior to hyperparameter optimization, in accordance with one or more embodiments.

FIG. 5 shows a flowchart of the steps involved in automating model selection based on dynamic dataset fittings of time-series data, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

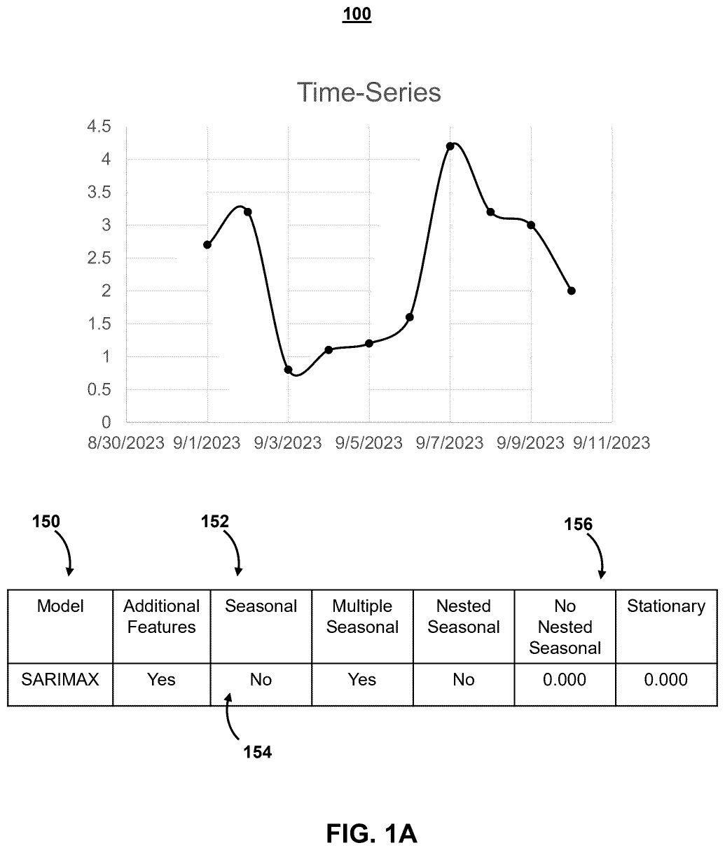

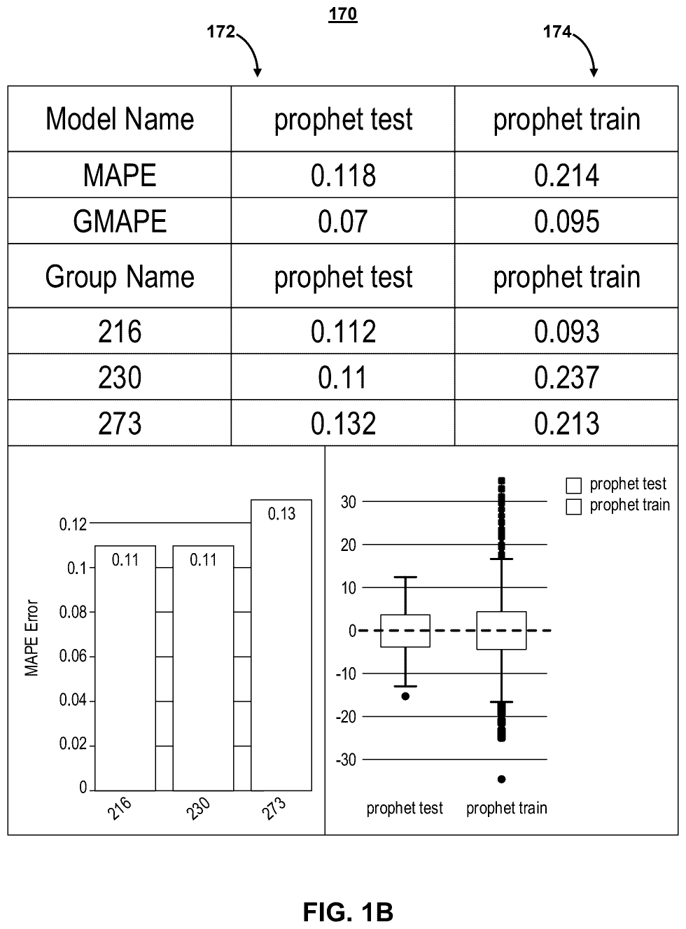

FIG. 1A shows an illustrative diagram of time-series data, in accordance with one or more embodiments. For example, dataset 100 may comprise data used to automate model selection based on dataset fittings of time-series data prior to hyperparameter optimization. Additionally or alternatively, a system may use dataset 100 to minimize development time in artificial intelligence models by automating model selection based on dataset fittings of time-series data prior to hyperparameter optimization. As described herein, a model development lifecycle may involve the various stages and processes involved in creating, training, evaluating, deploying, and/or maintaining models. It is a structured framework that helps guide the development of models in a systematic and effective manner.

As stated above, in the model development lifecycle, choosing the best model to fit a given dataset and optimizing its hyperparameters is an incredibly time-consuming and tedious process. This is particularly true for time-series data. For example, in time-series forecasting, some models will be better suited to fit a given dataset of certain attributes such as the seasonal periods, presence of trend, and/or smoothness of the data. As such, certain time-series forecasting models may not be effective if there is no seasonality present in the data, whereas other time-series forecasting models may be very effective if the dataset is stationary. Accordingly, information about these attributes (e.g., a profile) of the time-series dataset may be used to help determine which model may be most effective at fitting a given dataset.

Fitting a dataset in artificial intelligence models may refer to the process of training a model using available data. Before fitting a dataset, the system may need to preprocess the data to make it suitable for training. This includes tasks such as handling missing values, scaling/normalizing features, encoding categorical variables, and splitting the dataset into training and testing sets. The system may then select an algorithm or model that is appropriate for a task. The choice of the model depends on the type of problem (classification, regression, clustering, etc.) and the characteristics of the data. The system may create an instance of the chosen model and configure its hyperparameters. Hyperparameters control various aspects of the learning process, and the system may need to experiment with different values to achieve optimal performance. The system may then use training data to train (fit) the model. This involves presenting the input features and corresponding target labels (or output) to the model so that it can learn the underlying patterns in the data. During training, the model may use a loss function to measure how well it is performing compared to the actual target values. The optimization algorithm (like stochastic gradient descent) then adjusts the model's parameters (weights and biases) to minimize this loss function. The training process is usually performed in iterations or epochs. In each iteration, the model updates its parameters based on a subset of the training data. This helps the model gradually improve its performance. After each epoch, the system can evaluate the model's performance on a validation set. This helps the system monitor how well the model is generalizing to data it has not seen before.

For example, the system may receive a first dataset, wherein the first dataset comprises one or more categories of data trends. A dataset may comprise a structured collection of data points, usually organized into rows and columns, that is used for various purposes, including analysis, research, and training machine learning models. Datasets contain information related to a specific topic, domain, or problem and are used to extract meaningful insights or to train and evaluate algorithms and models. In the context of machine learning, a dataset typically consists of two main components: features and labels. Features (or attributes) are the characteristics or variables that describe each data point. Features are represented as columns in a tabular dataset. For example, if the system is working with a dataset of houses, features could include attributes such as the number of bedrooms, square footage, location, etc. Labels, in contrast, may comprise targets and/or responses. For example, in supervised learning tasks, each data point often has an associated label that represents the output or target value the system wants the model to predict. For instance, if the system is building a model to predict house prices, the labels would be the actual prices of the houses in the dataset. Datasets come in various formats and sizes, ranging from small tables with a few rows and columns to large and complex databases containing millions of records. They can be generated manually, collected from real-world sources, or obtained from publicly available repositories. Common types of datasets include: structured datasets (e.g., tabular datasets with rows and columns, often stored in formats like CSV (Comma-Separated Values), Excel spreadsheets, or databases); image datasets (e.g., collections of images, often used for computer vision tasks, where each image is treated as a data point, and the pixels constitute the features); text datasets (e.g., textual data, such as reviews, articles, or tweets, which can be used for natural language processing (NLP) tasks); time-series datasets (e.g., sequences of data points ordered by time, such as stock prices, weather measurements, or sensor readings); and graph datasets (e.g., data organized in a graph structure, with nodes and edges representing relationships between entities). Datasets are fundamental for various data-driven tasks, including exploratory data analysis, statistical analysis, and machine learning model development and evaluation.

Dataset 100 may comprise time-series data. As described herein, “time-series data” may include a sequence of data points that occur in successive order over some period of time. In some embodiments, time-series data may be contrasted with cross-sectional data, which captures a point in time. A time series can be taken on any variable that changes over time. The system may use a time series to track the variable (e.g., price) of an asset (e.g., security) over time. This can be tracked over the short term, such as the price of a security on the hour over the course of a business day, or the long term, such as the price of a security at close on the last day of every month over the course of five years. The system may generate a time-series analysis. For example, a time-series analysis may be useful to see how a given asset, security, and/or value related to other content changes over time. It can also be used to examine how the changes associated with the chosen data point compare to shifts in other variables over the same time period. For example, with regard to retail loss, the system may receive time-series data for the various sub-segments indicating daily values for theft, product returns, etc.

The time-series analysis may determine various trends such as a secular trend, which describes the movement along the term; a seasonal variation, which represents seasonal changes; cyclical fluctuations, which correspond to periodic but not seasonal variations; and irregular variations, which are other nonrandom sources of series variations. The system may maintain correlations for this data during modeling. In particular, the system may maintain correlations through non-normalization as normalizing data inherently changes the underlying data, which may render correlations, if any, undetectable and/or lead to the detection of false positive correlations. For example, modeling techniques (and the predictions generated by them), such as rarefying (e.g., resampling as if each sample has the same total counts), total sum scaling (e.g., dividing counts by the sequencing depth), and others, and the performance of some strongly parametric approaches, depends heavily on the normalization choices. Thus, normalization may lead to lower model performance and more model errors. The use of a non-parametric bias test alleviates the need for normalization, while still allowing the methods and systems to determine a respective proportion of error detections for each of the plurality of time-series data component models. Through this unconventional arrangement and architecture, the limitations of the conventional systems are overcome. For example, non-parametric bias tests are robust to irregular distributions, while providing an allowance for covariate adjustment. Since no distributional assumptions are made, these tests may be applied to data that has been processed under any normalization strategy or not processed under a normalization process at all.

As referred to herein, a “data stream” may refer to data that is received from a data source that is indexed or archived by time. This may include streaming data (e.g., as found in streaming media files) or may refer to data that is received from one or more sources over time (e.g., either continuously or in a sporadic nature). A data stream segment may refer to a state or instance of the data stream. For example, a state or instance may refer to a current set of data corresponding to a given time increment or index value. For example, the system may receive time-series data as a data stream. A given increment (or instance) of the time-series data may correspond to a data stream segment.

For example, in some embodiments, the analysis of time-series data presents comparison challenges that are exacerbated by normalization. For example, a comparison of original data from the same period in each year does not completely remove all seasonal effects. Certain holidays such as Easter and Lunar New Year fall in different periods in each year, hence they will distort observations. Also, year-to-year values will be biased by any changes in seasonal patterns that occur over time. For example, consider a comparison between two consecutive March months (i.e., compare the level of the original series observed in March for 2023 and 2024). This comparison ignores the moving holiday effect of Easter. Easter occurs in April for most years but if Easter falls in March, the level of activity can vary greatly for that month for some series. This distorts the original estimates. A comparison of these two months will not reflect the underlying pattern of the data. The comparison also ignores trading day effects. If the two consecutive months of March have different compositions of trading days, it might reflect different levels of activity in original terms even though the underlying level of activity is unchanged. In a similar way, any changes to seasonal patterns might also be ignored. The original estimates also contain the influence of the irregular component. If the magnitude of the irregular component of a series is strong compared with the magnitude of the trend component, the underlying direction of the series can be distorted. While data may, in some cases, be normalized to account for this issue, the normalization of one data stream segment (e.g., for one component model) may affect another data stream segment (e.g., for another component model). Individual normalizations may distort the relationship and correlations between the data, leading to issues and negative performance of a composite data model.

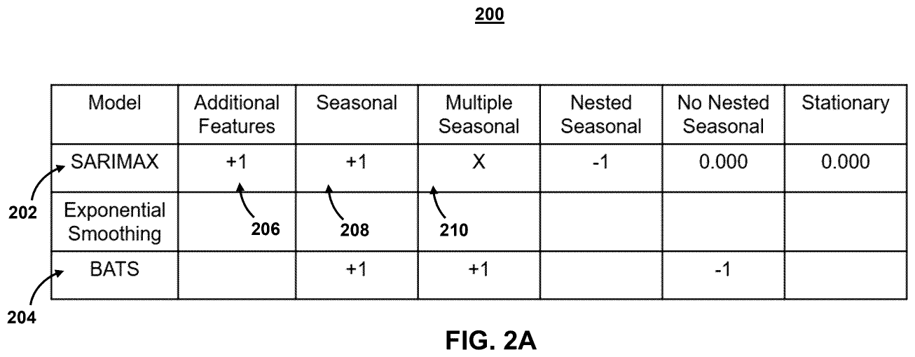

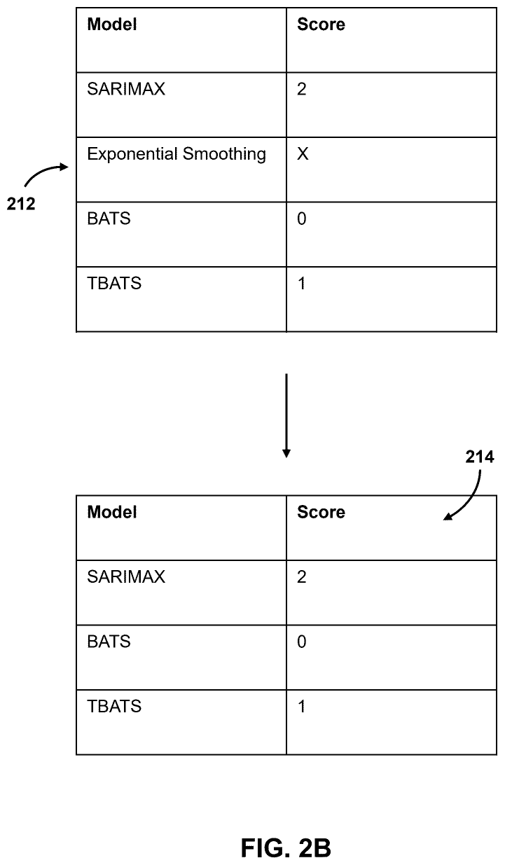

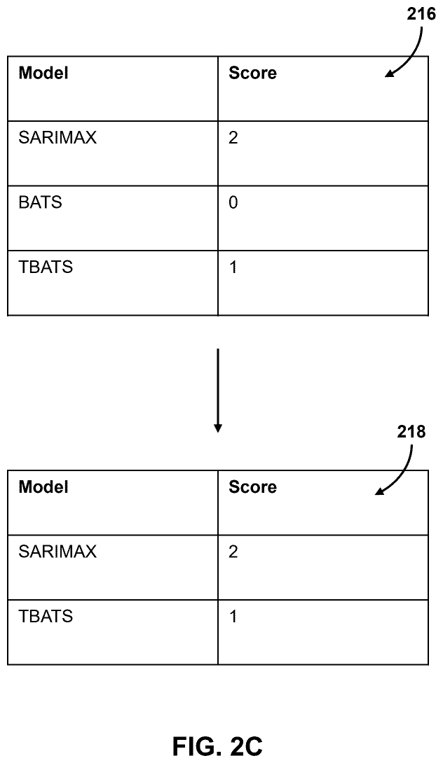

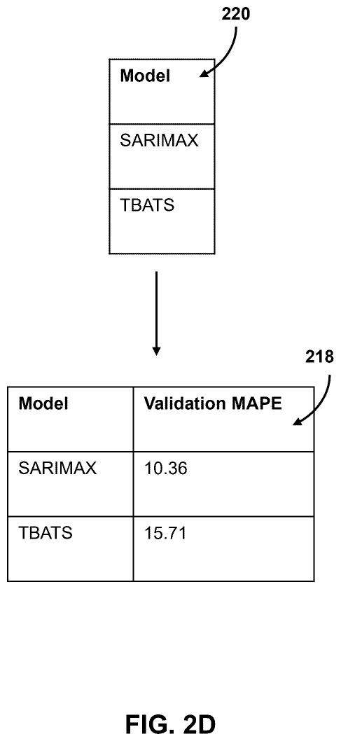

Table 150 may indicate outputs of a plurality of statistical models. For example, each row of table 150 may correspond to a model used to generate predictions based on a given dataset (e.g., “SARIMAX” in table 150), whereas each column of table 150 may correspond to a given statistical model that performs a different statistical analysis. For example, a first model of the plurality of statistical models (e.g., corresponding to column 152) may determine a value used to predict seasonality in data. The system may then use the value (e.g., value 154) to apply a score (e.g., score 206 (FIG. 2A)).

As referred to herein, a statistical analysis may encompass techniques used to analyze data and extract meaningful insights. These techniques help researchers, analysts, and data scientists understand patterns, relationships, and trends in data. In some embodiments, the system may determine whether data is spiky based on value 156.

For example, for automated model selection for time-series datasets, it is important to be able to determine whether or not the dataset contains spiky data, as certain time-series models cannot be fit properly to data that exhibits large swings. The system may achieve this by scanning a given dataset for periods of spikiness that are independent of the specific range of the overall dataset and do not use any measure of variance of the data.

For example, the system may receive a time-series dataset. The system may then determine a number of points to check within a sliding window across the dataset, as well as a maximum tolerable percent change with respect to the current range of the data in the sliding window that determines the threshold for calling data spiky (e.g., a “spiky threshold”), and the threshold value may be between 0 and 1.

For this process, the system iterates through the time-series dataset from the beginning, choosing a sliding window of a size of the number (N) of points the user selected. For each sliding window of N points, the system finds the range between the maximum and minimum values in the window. The system then determines the successive differences between each value of the points in the window and divides them by the window's range. If the absolute value of any of these values is greater than the spiky threshold value set by the user, the system exits out of the process and returns the dataset with an indication that it contained spiky data. If it ran to completion without identifying any spiky data, the system exits and returns an indication that it did not identify spiky data at the given parameters.

One type or category of statistical analysis is descriptive statistics. Descriptive statistics summarize and describe the main features of a dataset. This includes measures such as mean, median, mode, standard deviation, variance, and percentiles. Descriptive statistics provide a basic overview of the data's central tendency, variability, and distribution. Table 150 may list these results as an array of data values that comprises an aggregate statistical profile for a given model, wherein the given model may be used to generate predictions based on the dataset.

Another type of statistical analysis is inferential statistics. Inferential statistics involves making predictions or drawing conclusions about a population based on a sample of data. Techniques like hypothesis testing, confidence intervals, and regression analysis are used to infer insights about larger datasets. Hypothesis testing is used to make decisions about whether a particular hypothesis about a population is likely true or not. It involves comparing sample data to a null hypothesis and assessing the likelihood of observing the data if the null hypothesis is true.

Another type of statistical analysis is regression analysis. Regression analysis is used to understand the relationship between one or more independent variables (features) and a dependent variable (target). It helps model the relationship and predict the value of the dependent variable based on the values of the independent variables. Another type of statistical analysis is analysis of variance (ANOVA). ANOVA is used to analyze the differences among group means in a dataset. It is often used when there are more than two groups to compare. ANOVA assesses whether the means of different groups are statistically significant. Another type of statistical analysis is a chi-square test. The chi-square test is used to determine whether there is a significant association between categorical variables. It is commonly used to analyze contingency tables and assess whether observed frequencies are significantly different from expected frequencies. Another type of statistical analysis is time-series analysis. Time-series analysis focuses on data points collected over time. Techniques like moving averages, exponential smoothing, and autoregressive integrated moving average (ARIMA) models are used to analyze trends, seasonality, and patterns in time-series data. Another type of statistical analysis is cluster analysis. Cluster analysis is used to group similar data points together based on their characteristics. It is often used for segmentation and pattern recognition in unsupervised learning tasks.

Another type of statistical analysis is factor analysis. Factor analysis is used to identify patterns of relationships among variables. It aims to reduce the number of variables by grouping them into latent factors that explain the underlying variance in the data. Another type of statistical analysis is principal component analysis (PCA). PCA is a dimensionality reduction technique that transforms high-dimensional data into a lower-dimensional space while retaining as much variance as possible. It is commonly used to reduce noise and extract important features from data.

FIG. 1B shows an illustrative user interface for automating model selection and hyperparameter optimization, in accordance with one or more embodiments. For example, user interface 170 may represent an interface used to perform model selection and/or adjust hyperparameter optimization. For example, user interface 170 may be used to review model and/or hyperparameter performance (e.g., in order to train, tune, or fit models and/or hyperparameters).

The system may perform hyperparameter tuning to optimize the model's settings for better performance. For example, the system may compare test performance 172, which may comprise a performance performed by a model on test data to train performance, to test performance 174, which may comprise a performance performed by a model on test data to train performance. Once the training is complete and the system meets a threshold level of performance, the system can evaluate the model's performance on a separate testing dataset. This gives the system a final assessment of how well the model is expected to perform on new, unseen data. If the model meets the performance requirements, the system can deploy the model to make predictions on new data. This may involve integrating the trained model into another application or system. The fitting process involves a balance between underfitting (when the model is too simple to capture the underlying patterns) and overfitting (when the model learns noise in the training data and performs poorly on new data). Regularization techniques and careful model selection can help mitigate these issues. Overall, fitting a dataset involves selecting a model, training it on the data, monitoring its performance, and optimizing its settings for the best results.

As referred to herein, a “modeling error” or simply an “error” may correspond to an error in the performance of the model. In some embodiments, an error may be used to determine an effect on performance of a model. For example, an error in a model may comprise an inaccurate or imprecise output or prediction for the model. This inaccuracy or imprecision may manifest as a false positive or a lack of detection of a certain event. These errors may occur in models corresponding to a particular hyperparameter, which result in inaccuracies for predictions and/or output based on the hyperparameter, and/or the errors may occur in models corresponding to an aggregation of multiple hyperparameters that result in inaccuracies for predictions and/or outputs based on errors received in one or more predictions of the plurality of hyperparameters and/or an interpretation of the predictions of the models based on the plurality of hyperparameters.

Hyperparameter tuning is the process of selecting the optimal values for hyperparameters in a machine learning model. Hyperparameters are parameters that are set before the learning process begins and control various aspects of the training process. They are not learned from the data but are determined by the user or data scientist based on domain knowledge, experimentation, and heuristics. Some examples of hyperparameters in machine learning algorithms include learning rate, regularization strength, number of hidden units or layers in a neural network, kernel parameters in support vector machines, and so on.

Hyperparameter tuning is important because the performance of a machine learning model is highly dependent on the values of these hyperparameters. Poorly chosen hyperparameters can lead to suboptimal model performance, including overfitting or underfitting. The goal of hyperparameter tuning is to find the set of hyperparameters that results in the best possible performance on the validation or test dataset.

There are several methods for hyperparameter tuning, including grid searching. This involves specifying a grid of possible hyperparameter values and systematically trying out all combinations of values. It is simple but can be computationally expensive. Another example of hyperparameter tuning is random searching. Instead of trying all possible combinations, random searching samples a fixed number of random combinations from the hyperparameter space. This can be more efficient than grid searching. Another example of hyperparameter tuning is Bayesian optimization. This is a more sophisticated approach that builds a probabilistic model of the relationship between hyperparameters and model performance. It then uses this model to intelligently select the next set of hyperparameters to try. Another example of hyperparameter tuning is gradient-based optimization. Some frameworks allow for using gradient-based optimization techniques to directly optimize hyperparameters alongside the model parameters.

The process of hyperparameter tuning involves a balance between exploration and exploitation. Exploring different hyperparameter values helps to find a better region in the hyperparameter space, while exploiting promising regions helps to refine the hyperparameter settings for optimal performance. Overall, hyperparameter tuning is a crucial step in the machine learning pipeline to achieve the best possible model performance on new, unseen data.

FIGS. 2A-D show illustrative diagrams for automating model selection based on dataset fittings of time-series data prior to hyperparameter optimization, in accordance with one or more embodiments.

For example, FIG. 2A shows matrix 200, which includes information about attributes of a dataset (e.g., dataset 100 (FIG. 1A)), used to help determine which model may be most effective at fitting a given dataset. Matrix 200 includes a plurality of rows and columns. The values in the plurality of rows and columns may constitute an aggregate statistical profile for a dataset that comprises a series of values corresponding to a plurality of respective outputs from a first plurality of statistical routines.

The series of values used to populate matrix 200 may be based on a respective effectiveness of a plurality of model types for generating predictions based on the one or more categories of data trends. For example, the system may input a first feature input into a first plurality of statistical routines to determine a first plurality of respective outputs, wherein the first plurality of statistical routines performs a respective first statistical analysis of the first feature input and wherein each of the first plurality of statistical routines is based on a first respective algorithm.

The system may score the various models using a profiling model. The profiling model may be used to understand the structure, content, and quality of a dataset. For example, the primary goal of data profiling is to gather insights about the data in order to make informed decisions about model selecting, hyperparameter tuning, etc. In particular, the profiling model may rely on a scoring policy that indicates which scores should be attributed to different profiles for different models (i.e., the results of the various statistical analyses). In some embodiments, the scoring policy may indicate which scores should be attributed to the plurality of respective outputs from a plurality of statistical routines performing respective first statistical analysis on a dataset (or a feature input based thereon). For example, each of the plurality of statistical routines may be based on a respective algorithm (e.g., to perform a different statistical analysis (e.g., to determine seasonality, multiple seasonality, nested seasonality, stationary trends, spiky data, smooth data, and/or additional features)).

In some embodiments, the profiling model may be based on a scoring policy. As described herein, a scoring policy may refer to a scoring function and/or scoring algorithm used to assign scores or ranks to different instances or data points (e.g., outputs of models) based on certain criteria. These criteria may be defined based on the statistical analysis. The purpose of a scoring policy is to enable decision-making and/or prioritization (e.g., regarding model training, hyperparameter tuning, etc.) based on the scores assigned to the instances.

The scoring of an output of a model in the context of modeling may refer to the prediction, classification, or response that the model generates based on the input features it has been provided. In other words, the model's output is the result of applying its learned patterns and relationships to the input data. Similarly, the scoring policy may use one or more types of classification, ranking, and/or anomaly detection.

For example, in binary classification, a scoring policy assigns scores to instances to determine their likelihood of belonging to one of the two classes. In non-binary classification, the scoring policy may assign scores to instances to determine their likelihood of belonging to a plurality of classes. Common scoring policies for classification tasks include logistic regression scores, probability scores, or decision function scores from support vector machines. In ranking tasks, instances are assigned scores to determine their order or position in a ranked list. This is common in information retrieval, search engines, and recommendation systems. For instance, a scoring policy might assign higher scores to documents that are more relevant to a search query. In reinforcement learning, a scoring policy is often represented by a policy network that assigns scores to different actions in a given state. This helps in determining the best action to take based on the expected future rewards. In ensemble methods such as random forests or gradient boosting, multiple base models are combined to make predictions. The scoring policy involves aggregating the predictions from individual models to make a final decision. The scoring policy may score model outputs, where the models perform one or more statistical analyses on a dataset.

Row 202 may list a plurality of different categories for data trends. The system may determine, based on the respective models, whether the dataset corresponds to one or more categories of data trends and provide a score that indicates a positive effect (e.g., score 206), disqualifying effect (e.g., score 208), and/or negative effect (e.g., score 210) for each category based on how that category (or lack thereof) affects a given model (e.g., model 204).

Determining trends in data involves identifying patterns and changes in values over time or across different data points. Detecting trends is important for understanding the underlying dynamics of a dataset and making informed decisions. In time-series data, trends refer to the long-term patterns or movements that persist over an extended period of time. Identifying and understanding different types of trends is important for making predictions, forecasting, and decision-making. One category of trends is an upward trend (increasing trend).

An upward trend occurs when the data values consistently increase over time. This suggests a positive relationship and indicates growth or improvement in the variable being measured. Another category of trends is a downward trend (decreasing trend). A downward trend is the opposite of an upward trend. Data values consistently decrease over time, indicating a negative relationship and potential decline in the variable. Another category of trends is a horizontal or flat trend. A flat trend occurs when data values remain relatively stable over time, showing little to no change. This could indicate a period of stability or equilibrium. Another category of trends is a seasonal trend. A seasonal trend involves repeated patterns that occur at regular intervals, often corresponding to seasons, months, days of the week, or specific events. Seasonal trends can be seen in sales data, temperature readings, and more. Another category of trends is a cyclical trend. Cyclical trends are longer-term patterns that do not have a fixed periodicity like seasons. They typically extend beyond a year and are influenced by economic, business, or social cycles. Cyclical trends can be observed in economic data, such as stock market fluctuations. Another category of trends is a damped trend. A damped trend occurs when an increasing or decreasing trend starts to level off over time. It suggests that the initial strong trend is weakening, possibly due to various influencing factors. Another category of trends is a step trend. A step trend involves sudden shifts or jumps in the data values, often due to external events or structural changes. Step trends can be challenging to identify and model accurately. Another category of trends is an exponential trend. An exponential trend occurs when the data values grow or decline at an exponential rate. This suggests a compounding effect over time. Another category of trends is a linear trend. A linear trend is a straight-line relationship between the data values and time. The slope of the line indicates the rate of change. Another category of trends is a quadratic trend. A quadratic trend is a curve that fits the data better than a straight line. It indicates a changing rate of change over time.

However, these attributes do not necessarily have a linear relationship with the effectiveness of a model. Moreover, in some cases, a dataset may have conflicting (or complementary) attributes that weigh on the effectiveness of a given model. As such, the systems and methods gather information about a time-series profile of a given dataset using a plurality of statistical tests to determine details such as stationarity, seasonality, and/or presence of trends. The systems and methods may then apply a scoring policy to the time-series profile to determine a score for each model. The systems and methods may then use the scoring policy to determine how a given time-series model may be affected (e.g., whether it is benefited, harmed, and/or disqualified entirely) by the details present in the time-series profile. The systems and methods may then filter, prioritize, and/or select models based on attributes of the time-series profile. Notably, an initial disqualification of a model prevents further expenditure of time and/or resources related to testing and/or training a given model. For example, as shown in FIG. 2B, the model corresponding to exponential smoothing has been disqualified based on disqualifying effect 212.

In contrast, as shown in FIG. 2C, models that are not disqualified may continue to be scored (e.g., scores 216) to allow for non-binary classification and/or analysis to account for the conflicting (or complementary) attributes that weigh on the effectiveness of a given model. That is, the system may aggregate the various values returned by the plurality of statistical routines into a series of scores. While models that are disqualified (e.g., model 214 (FIG. 2B) are eliminated, once all remaining models are scored, the system may select the top-scored models (e.g., scores 218) to be fit and tuned, and the model with the best validation score may be selected for use by a user.

As shown in FIG. 2D, the system may select high-scoring models 220 for fitting based on a dataset (e.g., dataset 100 (FIG. 1A)) and then evaluate the models (e.g., evaluations 222). By doing so, the system automates the profiling of the time-series dataset (which gathers information about what makes this dataset unique) and automatically selects and fits the best-suited models to the specific time-series profile. As such, the system saves countless hours for any user who wishes to apply time-series forecasting techniques to a given dataset and allows for the democratization of artificial intelligence by reducing the barrier to entry for many users to start forecasting.

For example, the system may select, based on the respective effectiveness of the plurality of model types, a first untrained model from a first plurality of untrained models for training, wherein the first plurality of untrained models comprises respective algorithms for time-series forecasting, and wherein each of the first plurality of untrained models comprises default hyperparameter tuning. An untrained model, which may be referred to as a “raw” or “initial” model, is a model that has not yet been exposed to any (or has been exposed to limited) training data or learning process. In its untrained state, the model lacks the knowledge or parameters necessary to make accurate predictions or classifications. When a model is first created, its parameters (weights and biases) are usually initialized randomly or with default values. At this point, the model is essentially a blank slate, and its predictions are based on these initial parameter values, which are unlikely to provide meaningful results. For example, consider a neural network designed to classify images of animals. Before training, this untrained neural network would not know how to distinguish between different animals because it has not learned any patterns from data.

For an untrained model to become useful, it needs to go through a training process. During training, the model is exposed to a labeled dataset, and it learns to adjust its parameters based on the input features and corresponding target labels. The optimization process (often using techniques like gradient descent) iteratively updates the model's parameters to minimize the difference between its predictions and the actual labels in the training data.

Through this training process, the model learns to recognize patterns, relationships, and features in the data, allowing it to make accurate predictions or classifications on new, unseen data. The process of training a model involves adjusting its parameters to fit the training data and capture the underlying patterns, which is why an untrained model is not yet capable of performing the desired task.

Based on selecting the first untrained model, the system may tune a first hyperparameter of the first untrained model using the first dataset to generate a tuned first model. The system may then generate for display, on a user interface, a recommendation for using the tuned first model for time-series forecasting. For example, generating recommendations on a user interface may involve leveraging algorithms and techniques to suggest relevant items, content, or actions to users based on their preferences, behavior, and/or historical interactions.

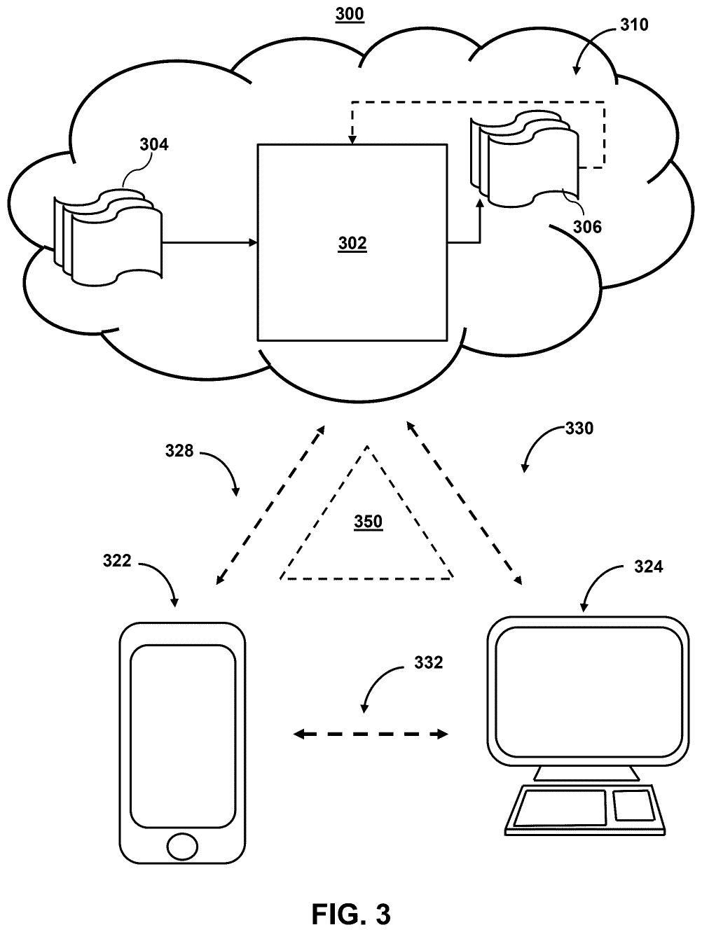

FIG. 3 shows illustrative components for a system used to automate model selection based on dataset fittings of time-series data prior to hyperparameter optimization, in accordance with one or more embodiments. For example, FIG. 3 may show illustrative components for minimizing development time in artificial intelligence models by automating model selection based on dataset fittings of time-series data prior to hyperparameter optimization. As shown in FIG. 3, system 300 may include mobile device 322 and user terminal 324. While shown as a smartphone and a personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or I/O circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., recommendations, queries, and/or notifications).

Additionally, as mobile device 322 and user terminal 324 are shown as a touchscreen smartphone and a personal computer, respectively, these displays also act as user input interfaces. It should be noted that in some embodiments, the devices may have neither user input interfaces nor displays and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred to collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., one or more categories of data trends and/or other predictions).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, backpropagation techniques may be utilized by model 302 where forward stimulation is used to reset weights on the “front” neural units. In some embodiments, stimulation and inhibition for model 302 may be more free flowing, with connections interacting in a more chaotic and complex fashion. During testing, an output layer of model 302 may indicate whether or not a given input corresponds to a classification of model 302 (e.g., one or more categories of data trends and/or other predictions).

In some embodiments, the model (e.g., model 302) may automatically perform actions based on outputs 306. In some embodiments, the model (e.g., model 302) may not perform any actions. The output of the model (e.g., model 302) may be used to generate recommendations and/or other predictions.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be a REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: front-end layer and back-end layer, where microservices reside. In this kind of architecture, the role of the API layer 350 may provide integration between front-end and back-end layers. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API platforms and their modules. API layer 350 may use a developer portal. API layer 350 may use strong security constraints applying WAF and DDOS protection, and API layer 350 may use RESTful APIs as standard for external integration.

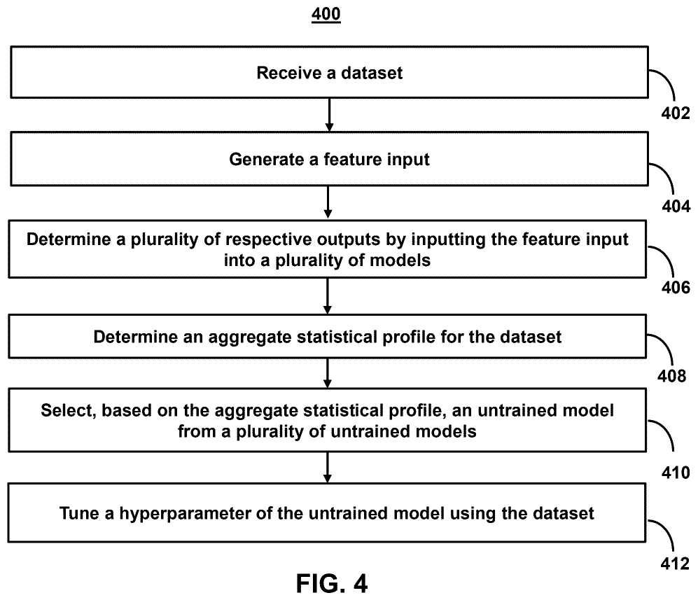

FIG. 4 shows a flowchart of the steps involved in automating model selection based on dataset fittings of time-series data prior to hyperparameter optimization, in accordance with one or more embodiments. For example, the system may use process 400 (e.g., as implemented on one or more system components described above) in order to minimize development time in artificial intelligence models by automating model selection based on dataset fittings of time-series data prior to hyperparameter optimization.

At step 402, process 400 (e.g., using one or more components described above) receives a dataset. For example, the system may receive a first dataset. For example, the first dataset may comprise payment card transaction data over a given time period. For example, payment card transaction data refers to the records of financial transactions made using credit cards, debit cards, and/or other electronic payments. These transactions involve the exchange of goods or services in return for payment, and the details of each transaction are recorded by the credit card issuer and the merchant involved. Transaction data is highly valuable for various purposes, including financial analysis, fraud detection, and consumer behavior analysis.

At step 404, process 400 (e.g., using one or more components described above) generates a feature input. For example, the system may generate a first feature input based on the first dataset. In the context of modeling, a feature input (often simply referred to as a “feature”) is a specific attribute or variable that is used as an input to a model for making predictions or classifications. Features are the measurable characteristics of the data that the machine learning algorithm uses to learn patterns and relationships in the data. In a dataset, each data point (also known as an observation or instance) is described by a set of features. These features represent the input variables that the model uses to make predictions or decisions. The goal of feature engineering is to select and transform relevant features that can help the model capture the underlying patterns in the data and improve its predictive performance.

At step 406, process 400 (e.g., using one or more components described above) determines a plurality of respective outputs by inputting the feature input into a plurality of statistical routines. For example, the system may input the first feature input into a first plurality of statistical routines to determine a first plurality of respective outputs, wherein the first plurality of statistical routines performs a respective first statistical analysis of the first feature input, and wherein each of the first plurality of statistical routines is based on a first respective algorithm.

In some embodiments, each routine of the plurality of statistical routines may test for a different statistical variation (e.g., smoothness, spiky data, seasonality, etc.). To determine the statistical variation for the first model over the first time period, the system may need to calculate descriptive statistics that provide insights into the variability of the data. For example, the system may gather the data (e.g., form the first dataset) over the first time period. This could be any relevant metric that the system wants to analyze, such as accuracy, error rate, revenue, etc. as well as other statistical metrics (e.g., mean, average, standard deviation, etc.). For example, the system may calculate descriptive statistics such as mean, variance, and/or standard deviation. To determine a mean, the system may add up all the data points and divide by the number of data points to get the average. The mean provides an overall sense of central tendency. To determine variance, for each data point, the system calculates the squared difference from the mean. The system may then sum up these squared differences and divide by the number of data points. Variance measures how much the data points spread out from the mean. For standard deviation, the system takes the square root of the variance. The standard deviation is a commonly used measure of dispersion or spread. For example, the system may determine a first time period for a first model of the first plurality of statistical routines. The system may determine a first statistical variation for the first model over the first time period. The system may determine a respective output of the first plurality of respective outputs for the first model based on the first statistical variation.

At step 408, process 400 (e.g., using one or more components described above) determines an aggregate statistical profile for the dataset. For example, the system determines an aggregate statistical profile for the dataset based on the first plurality of respective outputs. The system may aggregate the first plurality of respective outputs, which are generated based on a profiling model, to determine a first aggregate statistical profile for the first dataset. In some embodiments, the aggregate statistical profile may comprise a matrix. For example, the system may input the first plurality of respective outputs into the profiling model to determine the first aggregate statistical profile for the first dataset by generating a profile matrix for the first dataset. The system may then populate values of the profile matrix based on a comparison of the first plurality of respective outputs and respective model requirements for the first plurality of untrained models.

At step 410, process 400 (e.g., using one or more components described above) selects, based on the aggregate statistical profile, an untrained model. For example, the system may select, based on the first aggregate statistical profile, a first untrained model from a first plurality of untrained models for training, wherein the first plurality of untrained models comprises respective algorithms for time-series forecasting, and wherein each of the first plurality of untrained models comprises default hyperparameter tuning. For example, default hyperparameter tuning may refer to the process of using the default parameter values provided by a machine learning algorithm or library without explicitly adjusting them. Hyperparameters are parameters that are set before the training process begins and control aspects of the training process itself, rather than being learned from the data like model parameters.

When the system uses a machine learning algorithm or model library, it may use default hyperparameter values that are chosen based on some reasonable assumptions or heuristics. These default values are meant to work reasonably well for a wide range of tasks and datasets. Default hyperparameter tuning involves training and evaluating the model using these default values without any further customization.

Using the aggregate statistical profile, the system may filter, score, and/or disqualify models. In some embodiments, the system may compare scores to one or more thresholds to determine whether or not to filter, score, and/or disqualify models. For example, when selecting, based on the first aggregate statistical profile, the first untrained model from the first plurality of untrained models for training, the system may compare a first respective output of the first plurality of respective outputs to a threshold value. The system may then determine a difference between the first respective output and the threshold value, wherein selecting the first untrained model is based on the difference. The system may select the threshold based on characteristics of the dataset (e.g., size, type, age, etc.).

In some embodiments, the system may select, based on the first aggregate statistical profile, the first untrained model from the first plurality of untrained models for training by filtering the first plurality of untrained models based on the first aggregate statistical profile to generate a filtered subset of the first plurality of untrained models. The system may then select the first untrained model from the filtered subset. For example, the system may disqualify and/or filter some models from contention in order to preserve resources.

In some embodiments, the system may perform this filtering based on other information about the dataset not included in the aggregate statistical profile. For example, when selecting, based on the first aggregate statistical profile, the first untrained model from the first plurality of untrained models for training, the system may filter the first plurality of untrained models based on an age of the first dataset to generate a filtered subset of the first plurality of untrained models. The system may select the first untrained model from the filtered subset. Additionally or alternatively, the system may select, based on the first aggregate statistical profile, the first untrained model from the first plurality of untrained models for training by filtering the first plurality of untrained models based on a reliability of the first dataset to generate a filtered subset of the first plurality of untrained models. The system may then select the first untrained model from the filtered subset. Additionally or alternatively, the system may select, based on the first aggregate statistical profile, the first untrained model from the first plurality of untrained models for training by ranking the first plurality of untrained models based on the first aggregate statistical profile to generate a ranked order of the first plurality of untrained models. The system may then select the first untrained model based on the ranked order.

In some embodiments, the system may consider the amount of resources involved in training a particular model. For example, the system may select, based on the first aggregate statistical profile, the first untrained model from the first plurality of untrained models for training by determining respective training time predictions for each of the first plurality of untrained models based on the first aggregate statistical profile. The system may then select the first untrained model based on the respective training time predictions. Additionally or alternatively, the system may select, based on the first aggregate statistical profile, the first untrained model from the first plurality of untrained models for training by determining respective performance predictions for each of the first plurality of untrained models based on the first aggregate statistical profile. The system may select the first untrained model based on the respective performance predictions. Additionally or alternatively, the system may select, based on the first aggregate statistical profile, the first untrained model from the first plurality of untrained models for training by determining respective predictions for a number of hyperparameters requiring training for each of the first plurality of untrained models based on the first aggregate statistical profile. The system may select the first untrained model based on the respective predictions for the number of hyperparameters requiring training. Additionally or alternatively, the system may select, based on the first aggregate statistical profile, the first untrained model from the first plurality of untrained models for training by determining respective sample size requirements for training for each of the first plurality of untrained models based on the first aggregate statistical profile. The system may then select the first untrained model based on the respective sample size requirements for training.

Additionally or alternatively, the system may select, based on the first aggregate statistical profile, the first untrained model from the first plurality of untrained models for training by determining respective processing power requirements for training for each of the first plurality of untrained models based on the first aggregate statistical profile. The system may select the first untrained model based on the respective processing power requirements for training.

At step 412, process 400 (e.g., using one or more components described above) tunes a hyperparameter of the untrained model using the dataset. For example, the system may, based on selecting the first untrained model, tune a first hyperparameter of the first untrained model using the first dataset. For an untrained model to become useful, it needs to go through a training process. During training, the model is exposed to a labeled dataset, and it learns to adjust its parameters based on the input features and corresponding target labels. The optimization process (often using techniques like gradient descent) iteratively updates the model's parameters to minimize the difference between its predictions and the actual labels in the training data.

Through this training process, the model learns to recognize patterns, relationships, and features in the data, allowing it to make accurate predictions or classifications on new, unseen data. The process of training a model involves adjusting its parameters to fit the training data and capture the underlying patterns, which is why an untrained model is not yet capable of performing the desired task.

Based on selecting the first untrained model, the system may tune a first hyperparameter of the first untrained model using the first dataset to generate a tuned first model. The system may then generate for display, on a user interface, a recommendation for using the tuned first model for time-series forecasting. For example, generating recommendations on a user interface may involve leveraging algorithms and techniques to suggest relevant items, content, or actions to users based on their preferences, behavior, and/or historical interactions.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

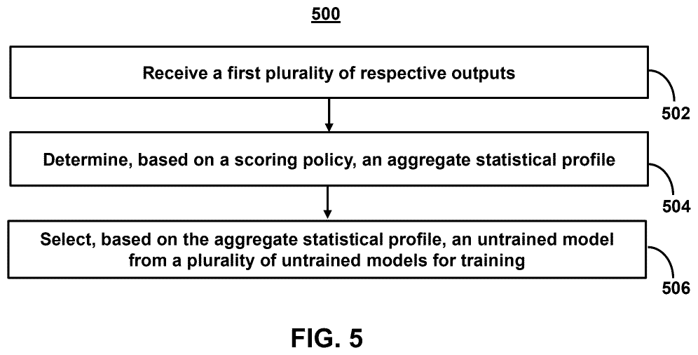

FIG. 5 shows a flowchart of the steps involved in automating model selection based on dynamic dataset fittings of time-series data, in accordance with one or more embodiments. For example, the system may use process 500 (e.g., as implemented on one or more system components described above) in order to minimize development time in artificial intelligence models by automating model selection based on dynamic dataset fittings of time-series data prior to hyperparameter optimization. While automatically selecting a well-suited time-series model given attributes about the profile of a given time-series dataset improves model selection, the process may be entirely reliant upon a hand-selected scoring policy, which determines how extracted profile details may affect how a model is fit to a dataset. To overcome technical problems related to this reliance, the system tunes the scoring policy to provide better predictions using a model.

At step 502, process 500 (e.g., using one or more components described above) receives a first plurality of respective outputs. For example, the system may receive a first plurality of respective outputs from a first plurality of statistical routines, wherein each of the first plurality of statistical routines performs a respective first statistical analysis on a first dataset.

In some embodiments, the system may use an expanding window strategy. For example, an expanding window strategy may be used in time-series analysis and forecasting to train and evaluate models. In this strategy, the size of the training data window gradually increases over time, allowing the model to learn from both past and more recent data. For example, the system may start with an initial training window (e.g., comprising a first time period) containing a relatively small portion of the available time-series data. This window represents the past observations that the model will use to learn patterns and relationships. The system may then determine the number of time steps into the future for which predictions are desired. The system may then train the model using the data within the current training window and make predictions for the specified prediction horizon. The system may then evaluate the model's predictions against the actual values in the validation or test set for the corresponding prediction horizon. The system may calculate relevant evaluation metrics, such as Mean Absolute Error (MAE) or Root Mean Squared Error (RMSE), to assess the model's performance. After making predictions for the current time step, the system may expand the training window to include additional data points. This allows the model to incorporate new observations and adapt to any changing patterns in the data. The system may then gradually expand the training window over time and making predictions for each new time step. For example, when receiving the first plurality of respective outputs from the first plurality of statistical routines, the system may determine a first time period for a first model of the first plurality of statistical routines. The system may determine a first statistical variation for the first model over the first time period. The system may determine a respective output, of the first plurality of respective outputs, for the first model based on the first statistical variation.

In some embodiments, each routine of the plurality of statistical routines may test for a different statistical variation (e.g., smoothness, spiky data, seasonality, etc.). To determine the statistical variation for the first model over the first time period, the system may need to calculate descriptive statistics that provide insights into the variability of the data. For example, the system may gather the data (e.g., form the first dataset) over the first time period. This could be any relevant metric that the system wants to analyze, such as accuracy, error rate, revenue, etc. as well as other statistical metrics (e.g., mean, average, standard deviation, etc.). For example, the system may calculate descriptive statistics such as mean, variance, and/or standard deviation. To determine a mean, the system may add up all the data points and divide by the number of data points to get the average. The mean provides an overall sense of central tendency. To determine variance, for each data point, the system calculates the squared difference from the mean. The system may then sum up these squared differences and divide by the number of data points. Variance measures how much the data points spread out from the mean. For standard deviation, the system takes the square root of the variance. The standard deviation is a commonly used measure of dispersion or spread. For example, the system may determine a first time period for a first model of the first plurality of statistical routines. The system may determine a first statistical variation for the first model over the first time period. The system may determine a respective output of the first plurality of respective outputs for the first model based on the first statistical variation.

At step 504, process 500 (e.g., using one or more components described above) determines, based on a scoring policy, an aggregate statistical profile. For example, the system may determine, based on a first scoring policy, a first aggregate statistical profile for the first dataset based on the first plurality of respective outputs, wherein the first scoring policy is generated using a model. For example, using the scoring policy, the system may run an optimization to determine what untrained model may perform best for a given dataset. In some embodiments, the system may generate a profile matrix for the first dataset and populate values of the profile matrix based on a comparison of the first plurality of respective outputs and respective model requirements for the first plurality of untrained models.

In some embodiments, the system may train the model by receiving a plurality of labeled datasets. For example, the system may receive a set of time-series datasets to tune the scoring policy to (along with some holdout datasets to test performance on). Additionally or alternatively, the system may use synthetic datasets that may be sampled from default settings. If synthetic datasets are used, the system may generate a threshold amount (e.g., 1000 datasets) to limit bias that are sampled from default provided settings.

The system may generate the first scoring policy based on the plurality of labeled datasets. For example, the system may determine respective weights for respective outputs from a plurality of statistical models in predicting performance of a given model on a given dataset, wherein each of the plurality of statistical models performs a respective statistical analysis. The system may then determine an algorithm for processing the respective weights. As one example, the system may run all the possible models on all the datasets and extract validation Mean Absolute Percentage Error (MAPE) scores using an expanding window strategy. A MAPE score may be the mean of all absolute percentage errors between the predicted and actual values. In some embodiments, when generating the scoring policy based on the plurality of labeled datasets, the system may determine respective predicted performances, based on the scoring policy, of a plurality of statistical routines on the plurality of labeled datasets. The system may determine respective actual performances of the plurality of statistical routines on the plurality of labeled datasets. The system may compare the respective predicted performances to the respective actual performances.

In some embodiments, the system may use a cost function to minimize the average error score across all the datasets. The cost function may be minimized using a Bayesian optimization algorithm, using the scoring policy table as tunable parameters, and using the cost function as the score to minimize. By doing so, the system selects the best model while using only the scoring policy from the profile details. This process may run for the number of iterations selected by the system, and the system may return a tuned scoring policy to use in forecasting automated model selection in future research or for use in production. For example, when comparing the respective predicted performances to the respective actual performances, the system may determine an average error score of the respective predicted performances and the respective actual performances. The system may apply a Bayesian optimization algorithm to tuning parameters of the scoring policy to minimize the average error score.

The system may generate, based on the first scoring policy, a model selection for processing test datasets. The system may then extract the time-series profiles and place them in a table for each of the datasets. The scoring policy may then be defined by the system as a grid (e.g., matrix) of values: time-series profile details as the columns and models as the rows. Each value in the table may be a continuous value between positive and negative infinity.

The system may validate, based on an accuracy of the model selection, the scoring policy. The system may then iterate through each dataset, applying the scoring policy table to each of the dataset's profile details, and extract a policy score for each model. The system may temporarily select the model with the top score from this process. The system may then find a model with the best validation score for this dataset from the previous fitting process. The system may then find the actual validation score for the model selected by the scoring policy process. These two validation scores may then be compared. The system may then define the error for this individual dataset as the difference between the validation scores of the two selected models. For example, the error may be zero if the scoring policy chooses the model that ended up having the best validation score.

In some embodiments, the system may find the model with the best validation score for a given dataset. The system may then find the actual validation score for the model selected by the scoring policy process. The system may compare these two validation scores. For example, the system may determine a predicted performance of the model selection on a given dataset. The system may determine an actual performance of the model selection on the given dataset. The system may compare the predicted performance to the actual performance.

In some embodiments, the system may use a cost function to minimize the average error score across all the datasets. The cost function may be minimized using a Bayesian optimization algorithm, using the scoring policy table as tunable parameters, and using the cost function as the score to minimize. By doing so, the system selects the best model while using only the scoring policy from the profile details. This process may run for the number of iterations selected by the system, and the system may return a tuned scoring policy to use in forecasting automated model selection in future research or for use in production. For example, the system may determine an average error score of the respective predicted performances and the respective actual performances. The system may apply a Bayesian optimization algorithm to tuning parameters of the scoring policy to minimize the average error score.

In some embodiments, the system may find the model with the best validation score for a given dataset and compare it to an unselected model. The system may then find the actual validation score for the model selected by the scoring policy process. The system may compare these two validation scores. The error for this individual dataset may be defined as the difference between the validation scores of the two selected models. For example, the error score may be zero if the scoring policy chooses the model that has the best validation score. For example, the system may determine a selected model's actual performance on a given dataset. The system may determine an unselected model's actual performance on the given dataset. The system may compare the selected model's actual performance to the unselected model's actual performance.

In some embodiments, the system may need to retrain and/or tune its scoring policy based on newly arrived data. Furthermore, the system may need to continue to use the model while the model is retrained in a continuous manner (e.g., as opposed to a batch manner). For example, the system may receive an additional labeled dataset. As one example, the system may have a database table that holds all the scoring policy values (e.g., a current scoring policy). The system may optimize the values in this table on a continuing basis. To do so, the system may use a separate database table that holds the following: a column for the location of an input dataset, several columns related to the profile details of this input dataset, and several columns for the validation scores of each supported model on the input dataset. For example, each input dataset may be a row in the table. Finally, there may be a server set up to run a continuous Bayesian optimization process to update values in the scoring policy table.

Accordingly, when the system receives new data (e.g., when a user submits a new dataset to the API (as a location/path of the input dataset)), the system may run a quick onboarding process to deliver its prediction as to which model may fit the dataset best. As part of this dataset onboarding process, the system may extract details about the time-series profile, which are determined ahead of time and which the scoring policy can interact with. With the time-series profile, the system can pull the current values of the scoring policy from the scoring policy database table. The system may then apply the values to the extracted dataset profile and return to the user which model had the top score (e.g., the one expected to perform best at fitting the user's dataset). The profile details and the path to the dataset may then be saved in the dataset profile table.

The system may generate a snapshot of the scoring policy for determining the first aggregate statistical profile while the model is retraining. The system may then generate a retrained model by retraining the model using the additional labeled dataset. For example, to avoid downtime for the model during new training, the system may run all supported models on the same dataset and extract their validation scores, saving all the values in the dataset profile table for the dataset. The Bayesian optimization algorithm that is continuously running on a server may now be able to reference the new onboarded dataset profile. The value the system is trying to minimize as part of this optimization process (e.g., the cost function) may be the average of the square of the difference between the chosen (e.g., by the scoring policy) model's validation score and the best actual validation score (across all models, for the given dataset), which may be averaged across all onboarded datasets. As such, every time a new dataset is onboarded, the Bayesian optimization error rate may rise slightly with the addition of the new dataset.

In some embodiments, the system may determine that the retrained model has a threshold accuracy. The system may then update the snapshot of the scoring policy based on the retrained model. For example, to handle the potential spike in optimization error when a new dataset is onboarded, a “snapshot” of scoring policy values may be frozen in the scoring policy table until the cost function drops to within 5% of the cost function from before the new dataset's addition. Once the cost function is within 5%, the scoring policy table values may be continuously updated by the system, and these new tuned values may be used until a new dataset is onboarded to begin the process again.

At step 506, process 500 (e.g., using one or more components described above) selects, based on the aggregate statistical profile, an untrained model from a plurality of untrained models for training. For example, the system may select, based on the first aggregate statistical profile, a first untrained model from a first plurality of untrained models for training, wherein the first plurality of untrained models may comprise respective algorithms for time-series forecasting, and wherein each of the first plurality of untrained models comprises default hyperparameter tuning.

In some embodiments, the system may filter the first plurality of untrained models based on the first aggregate statistical profile to generate a filtered subset of the first plurality of untrained models and select the first untrained model from the filtered subset. For example, using the aggregate statistical profile, the system may filter, score, and/or disqualify models. For example, the system may filter a plurality of available models based on the first scoring policy to generate a filtered subset of the plurality of available models. The system may then select an available model from the filtered subset. As one example, the system may compare a first respective output of the first plurality of respective outputs to a threshold value. The system may determine a difference between the first respective output and the threshold value, wherein selecting the first untrained model is based on the difference.

In some embodiments, the system may compare scores to one or more thresholds to determine whether or not to filter, score, and/or disqualify models. For example, when selecting, based on the first aggregate statistical profile, the first untrained model from the first plurality of untrained models for training, the system may compare a first respective output of the first plurality of respective outputs to a threshold value. The system may then determine a difference between the first respective output and the threshold value, wherein selecting the first untrained model is based on the difference. The system may select the threshold based on characteristics of the dataset (e.g., size, type, age, etc.).

In some embodiments, the system may, based on selecting the first untrained model, tune a first hyperparameter of the first untrained model using the first dataset. The system may then generate a first prediction using the first untrained model after tuning the first hyperparameter. For example, the system may then generate for display, on a user interface, a recommendation for using the tuned first model for time-series forecasting. For example, generating recommendations on a user interface may involve leveraging algorithms and techniques to suggest relevant items, content, or actions to users based on their preferences, behavior, and/or historical interactions.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for minimizing development time in artificial intelligence models by automating model selection based on dataset fittings of time-series data prior to hyperparameter optimization.
2. The method of the preceding embodiment, further comprising: receiving a first dataset; generating a first feature input based on the first dataset; inputting the first feature input into a first plurality of statistical routines to determine a first plurality of respective outputs, wherein the first plurality of statistical routines performs a respective first statistical analysis of the first feature input, and wherein each of the first plurality of statistical routines is based on a first respective algorithm; determining a first aggregate statistical profile for the first dataset; selecting, based on the first aggregate statistical profile, a first untrained model from a first plurality of untrained models for training, wherein the first plurality of untrained models comprises respective algorithms for time-series forecasting, and wherein each of the first plurality of untrained models comprises default hyperparameter tuning; and based on selecting the first untrained model, tuning a first hyperparameter of the first untrained model using the first dataset.
3. The method of any one of the preceding embodiments, wherein determining the first plurality of respective outputs further comprises: determining a first time period for a first model of the first plurality of statistical routines; determining a first statistical variation for the first model over the first time period; and determining a respective output, of the first plurality of respective outputs, for the first model based on the first statistical variation.
4. The method of any one of the preceding embodiments, wherein selecting, based on the first aggregate statistical profile, the first untrained model from the first plurality of untrained models for training further comprises: comparing a first respective output of the first plurality of respective outputs to a threshold value; and determining a difference between the first respective output and the threshold value, wherein selecting the first untrained model is based on the difference.
5. The method of any one of the preceding embodiments, wherein selecting, based on the first aggregate statistical profile, the first untrained model from the first plurality of untrained models for training further comprises: filtering the first plurality of untrained models based on the first aggregate statistical profile to generate a filtered subset of the first plurality of untrained models; and selecting the first untrained model from the filtered subset.
6. The method of any one of the preceding embodiments, wherein selecting, based on the first aggregate statistical profile, the first untrained model from the first plurality of untrained models for training further comprises: filtering the first plurality of untrained models based on an age of the first dataset to generate a filtered subset of the first plurality of untrained models; and selecting the first untrained model from the filtered subset.
7. The method of any one of the preceding embodiments, wherein selecting, based on the first aggregate statistical profile, the first untrained model from the first plurality of untrained models for training further comprises: filtering the first plurality of untrained models based on a reliability of the first dataset to generate a filtered subset of the first plurality of untrained models; and selecting the first untrained model from the filtered subset.
8. The method of any one of the preceding embodiments, wherein selecting, based on the first aggregate statistical profile, the first untrained model from the first plurality of untrained models for training further comprises: ranking the first plurality of untrained models based on the first aggregate statistical profile to generate a ranked order of the first plurality of untrained models; and selecting the first untrained model based on the ranked order.
9. The method of any one of the preceding embodiments, wherein selecting, based on the first aggregate statistical profile, the first untrained model from the first plurality of untrained models for training further comprises: determining respective training time predictions for each of the first plurality of untrained models based on the first aggregate statistical profile; and selecting the first untrained model based on the respective training time predictions.
10. The method of any one of the preceding embodiments, wherein selecting, based on the first aggregate statistical profile, the first untrained model from the first plurality of untrained models for training further comprises: determining respective performance predictions for each of the first plurality of untrained models based on the first aggregate statistical profile; and selecting the first untrained model based on the respective performance predictions.
11. The method of any one of the preceding embodiments, wherein selecting, based on the first aggregate statistical profile, the first untrained model from the first plurality of untrained models for training further comprises: determining respective predictions for a number of hyperparameters requiring training for each of the first plurality of untrained models based on the first aggregate statistical profile; and selecting the first untrained model based on the respective predictions for the number of hyperparameters requiring training.
12. The method of any one of the preceding embodiments, wherein selecting, based on the first aggregate statistical profile, the first untrained model from the first plurality of untrained models for training further comprises: determining respective sample size requirements for training for each of the first plurality of untrained models based on the first aggregate statistical profile; and selecting the first untrained model based on the respective sample size requirements for training.
13. The method of any one of the preceding embodiments, wherein selecting, based on the first aggregate statistical profile, the first untrained model from the first plurality of untrained models for training further comprises: determining respective processing power requirements for training for each of the first plurality of untrained models based on the first aggregate statistical profile; and selecting the first untrained model based on the respective processing power requirements for training.
14. The method of any one of the preceding embodiments, wherein inputting the first plurality of respective outputs into the profiling model to determine the first aggregate statistical profile for the first dataset further comprises: generating a profile matrix for the first dataset; and populating values of the profile matrix based on a comparison of the first plurality of respective outputs and respective model requirements for the first plurality of untrained models.
15. The method of any one of the preceding embodiments, further comprising: receiving a first plurality of respective outputs from the first plurality of statistical routines, wherein each of the first plurality of statistical routines performs a respective first statistical analysis on a first dataset; determining, based on a first scoring policy, a first aggregate statistical profile for the first dataset based on the first plurality of respective outputs, wherein the first scoring policy is generated using a model, and wherein the model is trained by: receiving a plurality of labeled datasets; generating a scoring policy based on the plurality of labeled datasets; generating, based on the scoring policy, a model selection for processing test datasets; and validating, based on an accuracy of the model selection, the scoring policy; and selecting, based on the first aggregate statistical profile, a first untrained model from a first plurality of untrained models for training, wherein the first plurality of untrained models comprises respective algorithms for time-series forecasting, and wherein each of the first plurality of statistical routines comprises default hyperparameter tuning.
16. The method of any one of the preceding embodiments, wherein determining, based on the first scoring policy, the first aggregate statistical profile for the first dataset based on the first plurality of respective outputs further comprises: receiving an additional labeled dataset; generating a snapshot of the scoring policy for determining the first aggregate statistical profile while the model is retraining; and generating a retrained model by retraining the model using the additional labeled dataset.
17. The method of any one of the preceding embodiments, further comprising: determining that the retrained model has a threshold accuracy; and updating the snapshot of the scoring policy based on the retrained model.
18. The method of any one of the preceding embodiments, further comprising: based on selecting the first untrained model, tuning a first hyperparameter of the first untrained model using the first dataset; and generating a first prediction using the first untrained model after tuning the first hyperparameter.
19. The method of any one of the preceding embodiments, wherein validating the accuracy of the model selection further comprises: determining a predicted performance of the model selection on a given dataset; determining an actual performance of the model selection on the given dataset; and comparing the predicted performance to the actual performance.
20. The method of any one of the preceding embodiments, wherein generating the scoring policy based on the plurality of labeled datasets further comprises: determining respective predicted performances, based on the scoring policy, of a plurality of statistical routines on the plurality of labeled datasets; determining respective actual performances of the plurality of statistical routines on the plurality of labeled datasets; and comparing the respective predicted performances to the respective actual performances.
21. The method of any one of the preceding embodiments, wherein comparing the respective predicted performances to the respective actual performances further comprises: determining an average error score of the respective predicted performances and the respective actual performances; and applying a Bayesian optimization algorithm to tuning parameters of the scoring policy to minimize the average error score.
22. The method of any one of the preceding embodiments, wherein validating the accuracy of the model selection further comprises: determining a selected model's actual performance on a given dataset; determining an unselected model's actual performance on the given dataset; and comparing the selected model's actual performance to the unselected model's actual
23. The method of any one of the preceding embodiments, wherein receiving the first plurality of respective outputs from the first plurality of statistical routines further comprises: determining a first time period for a first model of the first plurality of statistical routines; determining a first statistical variation for the first model over the first time period; and determining a respective output, of the first plurality of respective outputs, for the first model based on the first statistical variation.
24. The method of any one of the preceding embodiments, wherein generating, based on the scoring policy, a model selection for processing test datasets further comprises: filtering a plurality of available models based on the scoring policy to generate a filtered subset of the plurality of available models; and selecting an available model from the filtered subset.
25. The method of any one of the preceding embodiments, wherein generating a scoring policy based on the plurality of labeled datasets further comprises: determining respective weights for respective outputs from a plurality of statistical models in predicting performance of a given model on a given dataset, wherein each of the plurality of statistical models performs a respective statistical analysis; and determining an algorithm for processing the respective weights.
26. The method of any one of the preceding embodiments, wherein selecting, based on the first aggregate statistical profile, the first untrained model from the first plurality of untrained models for training further comprises: comparing a first respective output of the first plurality of respective outputs to a threshold value; and determining a difference between the first respective output and the threshold value, wherein selecting the first untrained model is based on the difference.
27. The method of any one of the preceding embodiments, wherein selecting, based on the first aggregate statistical profile, the first untrained model from the first plurality of untrained models for training further comprises: filtering the first plurality of untrained models based on the first aggregate statistical profile to generate a filtered subset of the first plurality of untrained models; and selecting the first untrained model from the filtered subset.
28. The method of any one of the preceding embodiments, wherein determining, based on the first scoring policy, the first aggregate statistical profile further comprises: generating a profile matrix for the first dataset; and populating values of the profile matrix based on a comparison of the first plurality of respective outputs and respective model requirements for the first plurality of untrained models.
29. One or more non-transitory, computer-readable mediums storing instructions that, when executed by a data processing apparatus, cause the data processing apparatus to perform operations comprising those of any of embodiments 1-28.
30. A system comprising one or more processors; and memory storing instructions that, when executed by the processors, cause the processors to effectuate operations comprising those of any of embodiments 1-28.
31. A system comprising means for performing any of embodiments 1-28.

What is claimed is:

1. A system for minimizing development time in artificial intelligence models by automating model selection based on dynamic dataset fittings of time-series data prior to hyperparameter optimization, the system comprising:
one or more processors; and
one or more non-transitory, computer-readable mediums comprising instructions that, when executed by the one or more processors, cause operations comprising:
receiving a first plurality of respective outputs from a first plurality of statistical routines, wherein each of the first plurality of statistical routines performs a respective first statistical analysis on a first dataset;
determining, based on a first scoring policy, a first aggregate statistical profile for the first dataset based on the first plurality of respective outputs, wherein the first scoring policy is generated using a model, and wherein the model is trained by:
receiving a plurality of labeled datasets;
generating a scoring policy based on the plurality of labeled datasets;
generating, based on the scoring policy, a model selection for processing test datasets; and
validating, based on an accuracy of the model selection, the scoring policy;
selecting, based on the first aggregate statistical profile, a first untrained model from a first plurality of untrained models for training, wherein the first plurality of untrained models comprises respective algorithms for time-series forecasting, and wherein each of the first plurality of untrained models comprises default hyperparameter tuning;
based on selecting the first untrained model, tuning a first hyperparameter of the first untrained model using the first dataset; and
generating a first prediction using the first untrained model after tuning the first hyperparameter.

2. A method for minimizing development time in artificial intelligence models by automating model selection based on dynamic dataset fittings of time-series data prior to hyperparameter optimization, the method comprising:
receiving a first plurality of respective outputs from a first plurality of statistical routines, wherein each of the first plurality of statistical routines performs a respective first statistical analysis on a first dataset;
determining, based on a first scoring policy, a first aggregate statistical profile for the first dataset based on the first plurality of respective outputs, wherein the first scoring policy is generated using a model, and wherein the model is trained by:
receiving a plurality of labeled datasets;
generating the first scoring policy based on the plurality of labeled datasets;
generating, based on the first scoring policy, a model selection for processing test datasets; and
validating, based on an accuracy of the model selection, the scoring policy; and
selecting, based on the first aggregate statistical profile, a first untrained model from a first plurality of untrained models for training, wherein the first plurality of untrained models comprises respective algorithms for time-series forecasting, and wherein each of the first plurality of untrained models comprises default hyperparameter tuning.

3. The method of claim 2, wherein determining, based on the first scoring policy, the first aggregate statistical profile for the first dataset based on the first plurality of respective outputs further comprises:
receiving an additional labeled dataset;
generating a snapshot of the scoring policy for determining the first aggregate statistical profile while the model is retraining; and
generating a retrained model by retraining the model using the additional labeled dataset.

4. The method of claim 3, further comprising:
determining that the retrained model has a threshold accuracy; and
updating the snapshot of the scoring policy based on the retrained model.

5. The method of claim 2, further comprising:
based on selecting the first untrained model, tuning a first hyperparameter of the first untrained model using the first dataset; and
generating a first prediction using the first untrained model after tuning the first hyperparameter.

6. The method of claim 2, wherein validating the accuracy of the model selection further comprises:
determining a predicted performance of the model selection on a given dataset;
determining an actual performance of the model selection on the given dataset; and
comparing the predicted performance to the actual performance.

7. The method of claim 2, wherein generating the scoring policy based on the plurality of labeled datasets further comprises:
determining respective predicted performances, based on the scoring policy, of a plurality of statistical routines on the plurality of labeled datasets;
determining respective actual performances of the plurality of statistical routines on the plurality of labeled datasets; and
comparing the respective predicted performances to the respective actual performances.

8. The method of claim 7, wherein comparing the respective predicted performances to the respective actual performances further comprises:
determining an average error score of the respective predicted performances and the respective actual performances; and
applying a Bayesian optimization algorithm to tuning parameters of the scoring policy to minimize the average error score.

9. The method of claim 2, wherein validating the accuracy of the model selection further comprises:
determining a selected model's actual performance on a given dataset;
determining an unselected model's actual performance on the given dataset; and
comparing the selected model's actual performance to the unselected model's actual performance.

10. The method of claim 2, wherein receiving the first plurality of respective outputs from the first plurality of statistical routines further comprises:
determining a first time period for a first model of the first plurality of statistical routines;
determining a first statistical variation for the first model over the first time period; and
determining a respective output, of the first plurality of respective outputs, for the first model based on the first statistical variation.

11. The method of claim 2, wherein generating, based on the first scoring policy, the model selection further comprises:
filtering a plurality of available models based on the first scoring policy to generate a filtered subset of the plurality of available models; and
selecting an available model from the filtered subset.

12. The method of claim 2, wherein generating the first scoring policy based on the plurality of labeled datasets further comprises:
determining respective weights for respective outputs from a plurality of statistical models in predicting performance of a given model on a given dataset, wherein each of the plurality of statistical models performs a respective statistical analysis; and
determining an algorithm for processing the respective weights.

13. The method of claim 2, wherein selecting, based on the first aggregate statistical profile, the first untrained model from the first plurality of untrained models for training further comprises:
comparing a first respective output of the first plurality of respective outputs to a threshold value; and
determining a difference between the first respective output and the threshold value, wherein selecting the first untrained model is based on the difference.

14. The method of claim 2, wherein selecting, based on the first aggregate statistical profile, the first untrained model from the first plurality of untrained models for training further comprises:
filtering the first plurality of untrained models based on the first aggregate statistical profile to generate a filtered subset of the first plurality of untrained models; and
selecting the first untrained model from the filtered subset.

15. The method of claim 2, wherein determining, based on the first scoring policy, the first aggregate statistical profile further comprises:
generating a profile matrix for the first dataset; and
populating values of the profile matrix based on a comparison of the first plurality of respective outputs and respective model requirements for the first plurality of untrained models.

16. One or more non-transitory, computer-readable mediums comprising instructions that, when executed by one or more processors, cause operations comprising:
receiving a first plurality of respective outputs from a first plurality of statistical routines, wherein each of the first plurality of statistical routines performs a respective first statistical analysis on a first dataset;
determining, based on a first scoring policy, a first aggregate statistical profile for the first dataset based on the first plurality of respective outputs, wherein the first scoring policy is generated using a model, and wherein the model is trained by:
receiving a plurality of labeled datasets;
generating the first scoring policy based on the plurality of labeled datasets;
generating, based on the first scoring policy, a model selection for processing test datasets; and
validating, based on an accuracy of the model selection, the scoring policy; and
selecting, based on the first aggregate statistical profile, a first untrained model from a first plurality of untrained models for training, wherein the first plurality of untrained models comprises respective algorithms for time-series forecasting, and wherein each of the first plurality of untrained models comprises default hyperparameter tuning.

17. The one or more non-transitory, computer-readable mediums of claim 16, wherein the instructions further cause operations comprising:
based on selecting the first untrained model, tuning a first hyperparameter of the first untrained model using the first dataset; and
generating a first prediction using the first untrained model after tuning the first hyperparameter.

18. The one or more non-transitory, computer-readable mediums of claim 16, wherein validating the accuracy of the model selection further comprises:
determining a predicted performance of the model selection on a given dataset;
determining an actual performance of the model selection on the given dataset; and
comparing the predicted performance to the actual performance.

19. The one or more non-transitory, computer-readable mediums of claim 17, wherein generating the scoring policy based on the plurality of labeled datasets further comprises:
determining respective predicted performances, based on the scoring policy, of a plurality of statistical routines on the plurality of labeled datasets;
determining respective actual performances of the plurality of statistical routines on the plurality of labeled datasets; and
comparing the respective predicted performances to the respective actual performances.

20. The one or more non-transitory, computer-readable mediums of claim 16, wherein determining, based on the first scoring policy, the first aggregate statistical profile for the first dataset based on the first plurality of respective outputs further comprises:
receiving an additional labeled dataset;
generating a snapshot of the scoring policy for determining the first aggregate statistical profile while the model is retraining; and
generating a retrained model by retraining the model using the additional labeled dataset.
